(19) United States
(12) Patent Application Publication
(10) Pub. No.: US 2005/0266994 A1
(43) Pub. Date: Dec. 1, 2005

(54) Planktonic algae as a delivery vector to control algae blooms

(76) Inventor: Kirk Lee Coppedge, Arlington, TX (US)

Correspondence Address: Mr. Kirk Lee Coppedge, 3204 Elkhart Court, Arlington, TX, 76016, US

(21) Appl. No.: 10/858,438

(22) Filed: Jun. 1, 2004

(51) Int. Cl. A01N 25/00; A01N 63/00

(52) U.S. Cl. 504/117; 504/358

(57) ABSTRACT

A composition for effective algae bloom control by treating collected planktonic algae with sodium hypochlorite and reintroduction to the body of water affected by algae bloom.

Field of Search:

References Cited: U.S. patent Documents

| | | |
|---|---|---|
| 4319041 | Mar. 1982 | Goff |
| 4647537 | Mar. 1987 | Shigemitsu |
| 4735014 | Apr. 1988 | Weber |
| 5292410 | Mar. 1994 | Sweeney |

Foreign Patent Documents:

| | | |
|---|---|---|
| 405007482 | Jan. 1993 | JP |

### BACKGROUND OF THE INVENTION

Ornamental ponds have become very popular and apart from the regular Maintenance that is required, the most annoying problem is algae blooms which are also known as green water. The main source of enjoyment with an ornamental pond is watching fish. When algae blooms the turbidity of the water gives the appearance of pea green soup, and with an intense bloom, visibility is reduced to less than one inch.

It is known in the prior art that the addition of barley straw to water environments will decrease the algae bloom through the natural decomposition of the straw into humeric compounds.

The prior art also includes a process for the aqueous extract of barley straw, and a process of partially decomposed barley straw inoculated with bacteria.

The prior art includes the use of coloring agents or water soluble dyes in an attempt to absorb the wavelengths of light that are preferred by planktonic algae.

The prior art also includes the use of various chemical herbicides and algaecides.

Experience has shown that these treatments are subject to a number of disadvantages.

Barley straw floating in the water is not aesthetically pleasing and barley straw extracts have limited shelf life due to continuing decomposition. All of the barley straw treatments utilize the production of humeric acids and as a class of acids have varying molecular weights and sizes. Common properties of humeric compounds include brown color and high solubility in water. At the concentrations needed to control algae blooms, the water becomes a dark brown color like a strong tea.

Coloring compounds or dyes have been shown to have limited effectiveness in stopping algae blooms and have little or no effect after a bloom starts.

Chemical herbicides and algaecides commercially available are very toxic to fish and present many environmental problems.

It is because of these disadvantages of the foregoing treatments that there is a need for a biological water treatment to control algae blooms in pond, lagoons, aquariums, aquaculture systems, waste water treatment, cooling towers, holding or conveying systems and red tide.

### BRIEF SUMMARY OF INVENTION

When planktonic algae is treated with 3% sodium hypochlorite solution until all chloroplasts are broken down removed from the solution, rinsed and dried, approximately one teaspoon of the resulting powder will stop an algae bloom in approximately five thousand gallons of water. The water remains clear because the invention does not utilize the production of humeric compunds. The invention has a stable shelf life as a dried powered.

### DETAILED DESCRIPTION OF THE INVENTION

Planktonic algae is collected by using a porous, fibrous filter medium. The planktonic algae is mixed with 3% sodium hypochlorite solution for the length of time necessary to breakdown all chloroplasts. After approximately five minutes the planktonic algae turns from bright green to a sandy brown color, and settles to the bottom of the container as an insoluble precipitate. The precipitate is then separated from the solution by physical means, either drawing off the bottom, decanting the solution or siphoning the solution from the top. The precipitate is washed with water to remove excess sodium hypochlorite, and separated from the solution in the same manner as the original treatment. After all sodium hypochlorite is washed out, the precipitate can be used wet or dried and stored for later use.

The precipitate is then put into the body of water containing the algae bloom in an amount appropriate for the quantity of water, with a guideline of approximately one teaspoon precipitate to approximately 5000 gallons of water. Depending on the amount of algae present, water will clear in one to three days.

The above description of the invention is intended to be illustrative and not limiting. Various changes or modifications in the embodiments described may occur to those skilled in the art and these can be made without departing from the spirit or scope of the invention as defined in the following claims.

1. A composition of planktonic algae as a delivery vector in aqueous solutions for the control of algae blooms.
A composition of planktonic algae treated untill all chloroplasts are broken down resulting in a precipitate of dead planktonic algae.
A composition comprising planktonic algae treated with 3% sodium hypochlorite solution until all chloroplasts are broken down resulting in a precipitate which is light brown in color, and and extracting the precipitate from the solution.
A process for making a composition comprising planktonic algae treated with 3% sodium hypochlorite solution until all chloroplasts are broken down resulting in a precipitate which is light brown in color which comprises the first step and a second step of extracting the precipitate from the solution of sodium hypochlorite.
